(19) United States
(12) Patent Application Publication
(10) Pub. No.: US 2011/0140299 A1
(43) Pub. Date: Jun. 16, 2011

(54) SEMI-CONTINUITY FIBER PREPREG MATERIAL, MANUFACTURING METHOD THEREOF, AND COMPOSITE MATERIAL MADE OF SEMI-CONTINUITY FIBER PREPREG MATERIAL

(76) Inventors: Mau-Yi Huang, Banqiao City (TW); Geng-Wen Chang, Taipei City (TW); Pai-Lu Wang, Taipei City (TW); Dar-Ping Juang, Zhonghe City (TW); Cheng-Huan Wang, Taipei City (TW)

(21) Appl. No.: 12/635,692

(22) Filed: Dec. 10, 2009

(51) Int. Cl. B29C 67/00; B32B 3/00; B05D 3/12; B29C 59/02; B26D 3/08

(52) U.S. Cl. 264/137; 428/156; 427/358; 264/320; 264/322; 83/862; 83/879

(57) ABSTRACT

The invention provides a semi-continuity fiber prepreg material, a manufacturing method thereof, and a composite material made of the semi-continuity fiber prepreg material. The semi-continuity fiber prepreg material includes a plurality of intermittency notches and/or continuity notches formed on a fiber prepreg material along at least one direction to make the fiber prepreg material soft and suitable for molding.

### BACKGROUND OF THE INVENTION

1. Field of the Invention

The invention relates to a composite material, and more particularly, to a semi-continuity fiber prepreg material, a manufacturing method thereof, and a composite material made of the semi-continuity fiber prepreg material.

2. Description of the Prior Art

The composite material is made of two or more kinds of materials; its strength primarily comes from reinforcement materials such as carbon fiber or glass fiber, etc., these reinforcement materials can be combined into a unit by a substrate such as an epoxy resin or a phenolic resin. The composite material is a designable material which can be cooperated with different reinforcement materials and substrates according to different applications. For example, the composite material made of carbon fiber (as the reinforcement material) with the epoxy resin as good structure properties, so that the composite material can be widely applied to the airplane industry, the transportation industry and the exercising equipments; the composite material made of glass fiber or silicon fiber with the phenolic resin has good heat isolation property, therefore, it is a good heat isolation material and a flame resistant material.

Carbon fiber fabrics and phenolic resin are usually combined to form a composite material that has advantageous mechanical and thermal properties, the carbon fiber fabrics being able to resist to temperatures above 2000° C. within a short duration and offer superior mechanical strength. This type of composite materials thus has become the principal thermal insulator in aerospace and defense technologies. Industrialized countries thus have put major investments in the development of this material with respect to every aspect including the raw material, the manufacture process, or the assembly of component parts.

The raw materials of the above-mentioned fiber reinforced resin composite material are shown in an impregnated form, for example, the most commonly used are a short fiber molding compound and a continuous fiber prepreg material. In general, when the requirement for the structure strength of the composite material component is not high and/or the main function is heat isolation and not flushed by the heating gas directly, or when the combustion time is short, the short fiber molding compound is taken into consideration to be used at first, and formed by being heated and pressed by a heat pressed mold and a heat pressed machine. Therefore, its manufacturing process is simple and complicated shapes can be made, the passing rate is high, the material using rate can reach 100%, and the cost of the manpower and equipment will be lower. The most commonly used short fiber molding compounds are a bulk molding compound and a sheet molding compound, the manufacturing method is to use a fiber of a certain length and the resin in a certain proportion to be premixed and stirred or be pressed to be a slice form, then to be baked into the semi-solid state. Since the composite material component made of the short fiber molding compound has lower structure strength, and the arranging way of fiber is not easy to be controlled, therefore, it is only suitable for the condition of short burning time or not be flushed by the heating gas directly. When the composite material component is applied to the environment which needs higher structure strength and stricter burning condition, the manufacturing process of long fiber or continuous fiber is needed. This is because the length of the fiber, the arranging way, and the angle between the fiber and the gas flow are all important factors of affecting the structure properties and burning properties of the composite material. Generally, when the fiber is longer and arranged based on appropriate angles, the heating resistant properties of the composite material is better, and its structure strength is stronger, however, the difficulties of manufacturing and forming are also increased, and the passing rate is affected by the quality stability of the material more seriously.

The long fiber and the short fiber composite materials are two extremes. To achieve better performance, higher cost will be spent; to cut down the cost, performance will be scarified. In practical applications, however, there are a wide range of alternatives that can balance between performance and cost depends on the environment of applications. For example, the product of MXSE-55 of the Cytec Engineered Materials Inc. in the United States is to impregnate the silicon fiber fabric into the rubber-modified phenolic resin followed by being baked to be a semi-solid state called fabric prepreg, and then chopped into squares of size ½-inch by ½-inch (12.5 mm) by an automatic chopping machine. When this chopped prepreg material is formed by mold to be a composite tube, its fiber will arrange along the wall of the finished product, therefore, the structure strength will be increased in considerable degrees. Another similar product MX-4926MC of the Cytec Engineering Company is to chop the carbon phenolic fiber fabric into squares of 12.5 mm. It was claimed the best fire resistant material for small rocket nozzle.

The above-mentioned chopped fabric prepreg material is to use a special chopping machine to chop the fiber prepreg material, since there is not this special type of chopping machine in the market, a specially designed chopping machine is needed, so the manufacturing cost is largely increased. The mechanism of the chopping machine is to make the material pass through the chopping knifes to be slices, and then chopped as squares by knifes. When the hardness of the fiber is higher, for example the carbon fiber, the chopping knife is easy to be over-heated, so that the resin will be soften and attacked on the knife; the knife must be continuously cleaned in the chopping process, the total production efficiency will be seriously affected.

### SUMMARY OF THE INVENTION

Therefore, the invention is to provide a semi-continuity fiber prepreg material, a manufacturing method thereof and a composite material made of the semi-continuity fiber prepreg material that can be formed in molding pressing method as fabric prepreg chopping material, and it will also be easier for construction. At the same time, the composite material made of the fabric prepreg material will have better structure properties than the prior arts.

For people who know this skill very well, the fabric prepreg of bigger sizes is hard to be formed by molding, even it is formed, it is easy to have imperfections such as resin rich and/or crevices, and this is because of the rigidity of the fiber fabric. According to the first embodiment, the invention uses a plurality of intermittency notches and/or continuity notches to release the rigidity of the fabric prepreg material to be a semi-continuity fiber prepreg material and suitable for molding. Wherein, the plurality of intermittency notches is formed on a region of the fiber prepreg material in a first direction, and the continuity notches is formed on the region in a second direction, and the plurality of intermittency notches crosses the continuity notches.

According to the second embodiment, a method of manufacturing a semi-continuity fiber prepreg material comprising the step of generating a plurality of notches on a fiber prepreg material along at least one direction, wherein the plurality of notches are intermittency notches or continuity notches, so that the fiber prepreg material forms the semi-continuity fiber prepreg material which is soft and suitable for molding.

According to the third embodiment, the composite material manufacturing method using semi-continuity fiber prepreg material, comprising the steps of (a) rolling a semi-continuity fiber prepreg material to be a tube billet or a cylinder billet; (b) putting the tube billet or the cylinder billet into a forming mold; (c) providing an axial pressure via a hot pressing machine and the forming temperature to make the tube billet or the cylinder billet become a composite material.

Above all, the semi-continuity fiber prepreg material, the manufacturing method thereof and a composite material made of the semi-continuity fiber prepreg material provided by the invention uses only an ordinary die knife and a standard punching machine to chop the necessary knife traces, the shape and the size of the block and the slice can be rapidly produced and selectively adjusted, so that the block form material and the slice form material are soft and a certain proportion of long fiber and short fiber at the same time. The semi-continuity fiber prepreg material provided by the invention can be the same with slice molding compound, and chopped and prearranged based on the shape of the finished product. The drawback that the fabric prepreg material is hard for construction can be largely improved, and the composite material made of the fabric prepreg material has better structural and heat resistant properties, therefore, it has great market potential.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1 shows a flowchart of the steps of manufacturing a semi-continuity fiber prepreg material according to an embodiment of the invention.

FIG. 2A shows a scheme diagram of a first kind of die knife.

FIG. 2B˜FIG. 2D show scheme diagrams of the first kind of die knife to chop the fiber prepreg material.

FIG. 3B shows a scheme diagram of a second kind of die knife to chop the semi-continuity fiber prepreg material.

FIG. 4 shows the curve diagrams of the three bending tests of the semi-continuity fabric prepreg, the general prepreg fabric, and the prepreg fabric in small block form.

FIG. 5 shows a flowchart of the method of manufacturing a composite material using the semi-continuity fiber prepreg material.

FIG. 6A shows a scheme diagram of forming the semi-continuity fiber prepreg material in the first type of mold.

FIG. 6B shows a scheme diagram of forming the semi-continuity fiber prepreg material in the second type of mold.

### DETAILED DESCRIPTION OF THE INVENTION

The invention provides a semi-continuity fiber prepreg material, a manufacturing method thereof and a composite material made of the semi-continuity fiber prepreg material. It should be noticed that the semi-continuity fiber prepreg material of the invention is not limited to have chopping notches along two directions. In practical applications, the semi-continuity fiber prepreg material can have chopping notches along only one direction, or the chopping notches along two directions can be intermittency notches. The only condition is that the semi-continuity fiber prepreg material is soft and suitable for being molded.

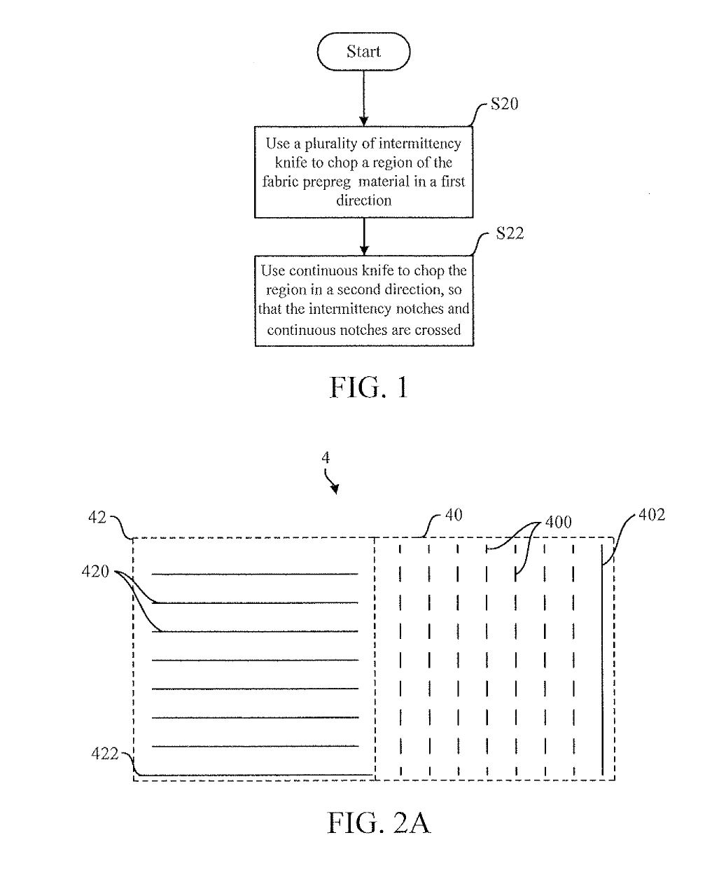

Please refer to FIG. 1. FIG. 1 shows a flowchart of the steps for manufacturing the semi-continuity fiber prepreg material according to an embodiment of the invention. In this embodiment, the fiber prepreg material can be a carbon fiber/phenolic resin prepreg fabric. The carbon fiber is woven using a PAN based carbon fiber of T300 in an 8 harness satin way; the phenolic resin is made of ammonia, formaldehyde, and phenol in a polymerization way, but not limited to these. With a continuous prepreg machine, the carbon fiber fabric passes a phenolic resin container, a thickness control wheel, and a baker at the temperature of 120±5° C. in a predetermined speed to make the carbon fiber/phenolic resin prepreg fabric which contains resin about 35-40%.

The semi-continuity fiber prepreg material manufacturing method forms notches along at least one direction on a fiber prepreg material, the notches along at least one direction can be continuity notches or intermittency notches to make the fiber prepreg material soft and suitable for molding.

In an embodiment, as shown in FIG. 1, at first, step S20 is performed to use a plurality of intermittency knife to chop a plurality of intermittency notch on a region of the fabric prepreg material in a first direction and define the width of the region. Then, step S22 is performed to use continuous knife to chop the region in a second direction, so that the continuous notches crossing the plurality of intermittency notch are generated and the length of the region is also defined.

In fact, the semi-continuity fiber prepreg material made by the semi-continuity fiber prepreg material manufacturing method is not limited to have chopping notches along two directions. The only condition is that the semi-continuity fiber prepreg material is soft and suitable for being molded. Therefore, the semi-continuity fiber prepreg material manufacturing method can also make a semi-continuity fiber prepreg material with notches along only one direction, or a semi-continuity fiber prepreg material with intermittency notches along two directions, but not limited to these.

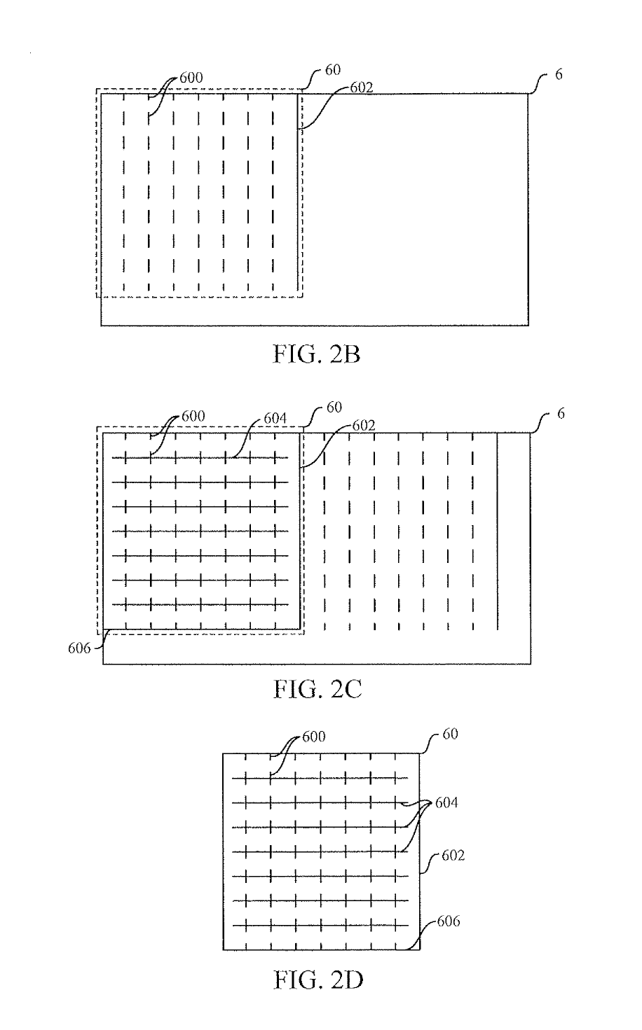

Please refer to FIG. 2A to FIG. 2D. FIG. 2A shows a scheme diagram of a first-type die 4; FIG. 2B to FIG. 2D show a scheme diagram of chopping the fabric prepreg material 6 with the first-type die 4 according to the invention. As shown in FIG. 2A, the die 4 includes a first knife set 40 and a second knife set 42. Wherein, the first knife set 40 includes a plurality of knife 400 (intermittency) and width knife 402 (continuous); the second knife set 42 includes a plurality of knife 420 (continuous) and length knife 422 (continuous). In this embodiment, a first knife set 40 is arranged in a horizontal direction, and a second knife set 42 is arranged in a vertical direction. However, in fact, the arrangement of the first knife set 40 and the second knife set 42 may have other probabilities, not limited to this case. And, the knife can be continuous or intermittency based on the different applications.

At first, the first knife set 40 of the die 4 is used to chop a plurality of intermittency notch 600 on the region 60 of the fabric prepreg material 6, and the width knife 402 of the first knife set 40 is used to chop the width 602 of the region 60, as shown in FIG. 2B.

Then, the die 4 is horizontally moved to chop the region 60 of the fabric prepreg material 6, so that the continuous knife 420 of the die 4 can chop continuous notches to cross the plurality of intermittency notch 600 on the region 60, and the length knife 422 of the die can chop the length 606 of the region. It should be noticed that since the knife of the die 4 performs a chopping action in a horizontal movement, so that a square material (the region 60) with the crossed intermittency notches 600 and continuous notches 604 and the vertical intermittency notch and width of the next region 60 can be generated at the same time, as shown in FIG. 2C. FIG. 2D shows the square material generated in this embodiment. Another possible method is to use the die with the type of the knife shown in FIG. 2D to directly chop the square material shown in FIG. 2D, but this die is very hard to be manufactured and maintained.

If the chopping machine has functions of automatically horizontal movement of the knife base and automatically material sending, a roll of fabric prepreg can be rapidly chopped into square materials with intermittency notches. After the chopping, each of the square materials has a mixture of 50% longer fiber and 50% shorter fiber, so that the square material has better softness and its properties are better than the short fiber molding compound and the fabric prepreg material chopped into small squares. In addition, the die 4 used in the invention is the auto-chopping machine widely applied in shoe manufacturing industry, not specially made chopping machine. And, the condition that the knife of the chopping machine used in prior art generates heat to soften the resin and be attacked to the knife will not happen easily.

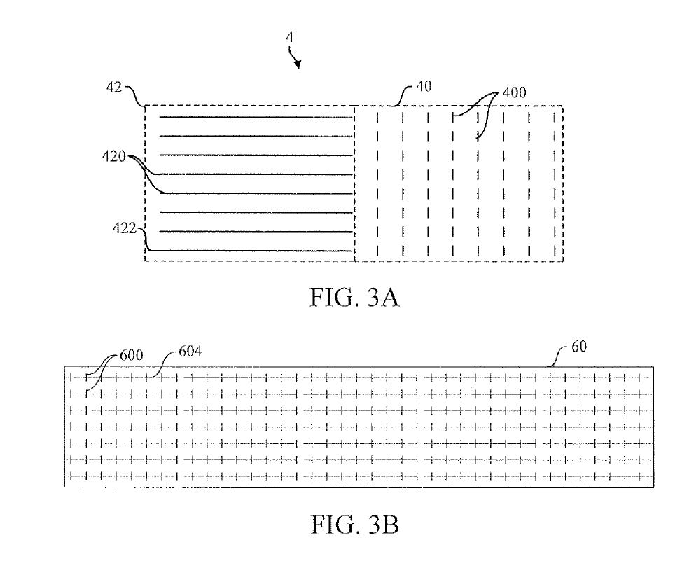

Please refer to FIG. 3A and FIG. 3B, FIG. 3A shows a scheme diagram of the second-type die 4; FIG. 3B shows a scheme diagram of chopping the fabric prepreg material 6 via the second-type die 4 in this invention. The difference between FIG. 3A and the above-mentioned FIG. 2A is that the die 4 of the FIG. 3A has no width knife 402 of FIG. 2A, therefore, the rectangle material shown in FIG. 3B is generated, not the square material shown in FIG. 2D.

The types and applications mentioned above are only embodiments of the semi-continuity fiber/resin prepreg material of the invention; people skilled in this technologic region can make other changes and applications easily. For example, different types of knives can be used based on requirements of the applications, so that the size of chopped squares can be smaller than 10 cm or larger than 10 cm, or chopped into rectangle or other forms, or the proportion of the longer fiber and the shorter fiber can be larger or smaller than 1:1. Or the entire roll of prepreg fabric is only chopped to form intermittency notches instead of being chopped to be a plurality of square, and further chopped to be the required size and shape when it is used. Moreover, the entire roll of fabric prepreg can be firstly chopped into a plurality of slice material with specific width (e.g., 100 mm) in a manual or automatic way, and then chopped into the require shapes and notches by the die and the ordinary chopping machine.

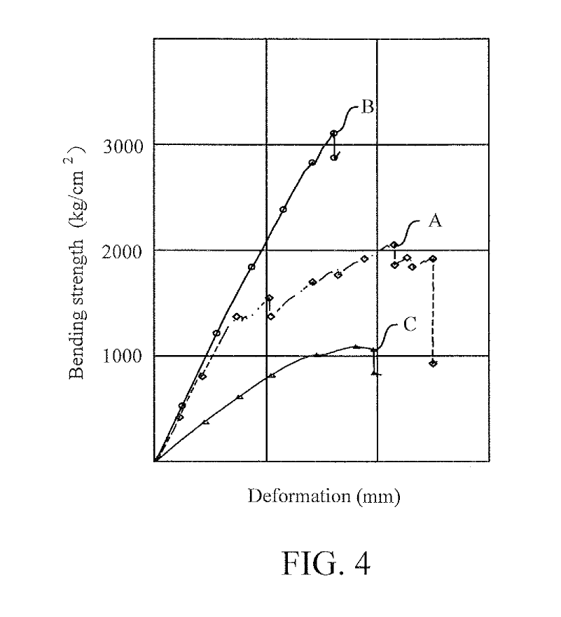

Please refer to FIG. 4, FIG. 4 shows the curve diagrams of the three bending tests on the plate sample made of the semi-continuity fabric prepreg A, the general prepreg fabric B, and the prepreg fabric in small block form C. As shown in FIG. 4, the semi-continuity fabric prepreg A of the invention is better than the block material C in the three bending tests. Compared to the general prepreg fabric B, although the semi-continuity fabric prepreg A of the invention has poor strength, due to the fact that it has larger deformed amount before the destruction, it has better toughness.

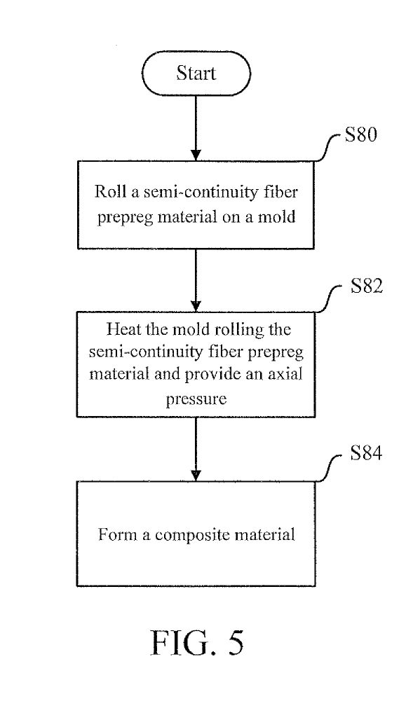

Please refer to FIG. 5. FIG. 5 shows a flowchart of the method of manufacturing a composite material using the semi-continuity fiber prepreg material. As shown in FIG. 5, this embodiment mainly makes a heat resistant tube using the above-mentioned semi-continuity fiber prepreg material.

At first, step S80 is performed to roll a semi-continuity fiber prepreg material on a mold; then, step S82 is performed to heat the mold rolling the semi-continuity fiber prepreg material, and provide an axial pressure; at last, step S84 is performed to form a composite material.

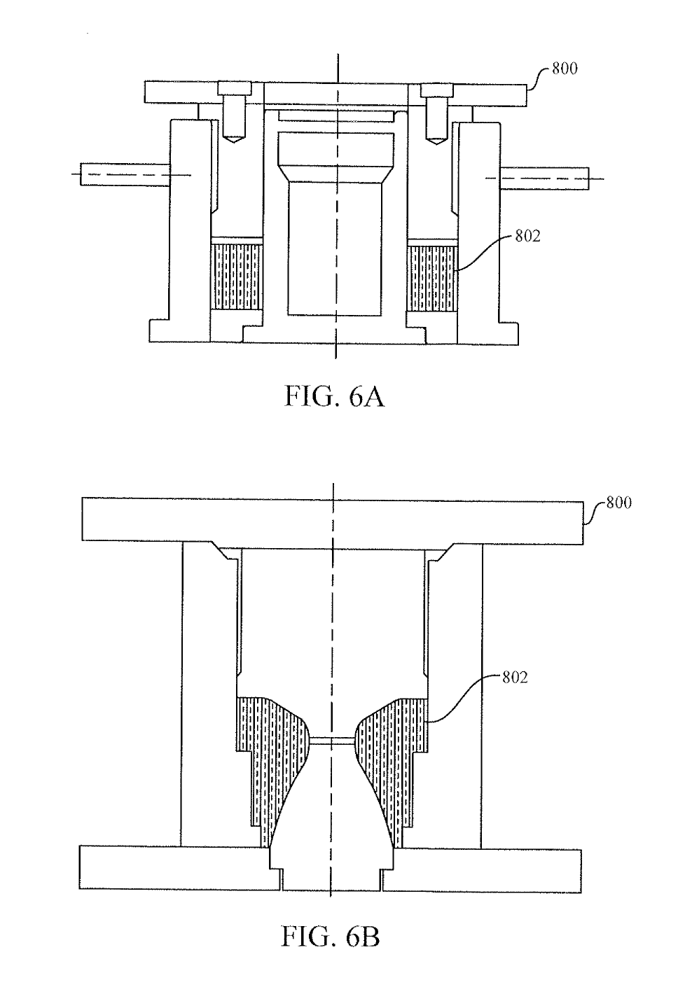

In practical applications, with the semi-continuity fabric prepreg chopped in the above-mentioned embodiments, since the notches make each slice material soft, and the semi-continuity fabric prepreg includes 50% longer fiber and 50% shorter fiber. Please refer to FIG. 6A, FIG. 6A shows a scheme diagram of forming the semi-continuity fabric prepreg 802 in the first-type mold. As shown in FIG. 6A, with the mold center of the mold 800, the semi-continuity fabric prepreg 802 can be rolled into a tube seed material to make the tube seed material form a 50% continuous fiber in ring direction, the mold 800 is heated and provided an axial pressure, so that the tube seed material will become a composite material with reinforced fiber in ring direction.

Since the semi-continuity fabric prepreg 802 is soft and is limited by the wall of the tube mold in radial direction, therefore, when it is pressed by an axial forming pressure, not only the continuousness of the continuous fiber in ring direction can be maintained, but also the tube seed material will become denser due to the radial shortening. In addition, the radial shortening will make the shorter fiber parallel to the axis tilt to or convert to horizontal or tilted arrangements (depends on the dense degree of the rolling), filled between the continuous fibers in ring direction to form a net structure.

Please refer to FIG. 6B. FIG. 6B shows a scheme diagram of forming the semi-continuity fiber prepreg material 802 in the second-type mold 800. As shown in FIG. 6B, the invention is not limited to manufacturing a straight tube by using the composite material, and the tube can be also a taper pipe, a cylinder, or a tube with irregular contours. In other words, the suitable mold 800 can be designed based on the shape and size of the finished product in this invention, therefore, the waste of the material and the following treatments can be reduced, and the continuous fiber in ring direction will not become discontinuous due to the treatments.

In practical applications, the carbonation/plastic infiltration process can be repeated to the carbon-phenolic material with the net structure in the invention, so that the carbon-phenolic composite material with the net structure can be made to be applied to the nozzle of the rocket, and applied to high-performance friction material (e.g., braking block), but not limited to this.

Compared to the prior arts, the semi-continuity fiber prepreg material, the manufacturing method thereof and a composite material made of the semi-continuity fiber prepreg material provided by the invention only uses an ordinary die knife and a standard punching machine to chop the necessary knife traces, and the shape and the size of the block and the slice can be rapidly produced and selectively adjusted, so that the block form material and the slice form material are soft and a certain proportion of long fiber and short fiber at the same time. The semi-continuity fiber prepreg material provided by the invention can be the same with slice molding compound, and chopped and prearranged based on the shape of the finished product. The drawback that the fabric prepreg material is hard for construction can be largely improved, and the composite material made of the fabric prepreg material has better structure and heat resistant properties, therefore, it has great market potential. Although the present invention has been illustrated and described with reference to the preferred embodiments thereof, it should be understood that it is in no way limited to the details of such embodiment but is capable of numerous modifications within the scope of the appended claims.

What is claimed is:

1. A semi-continuity fiber prepreg material, comprising:
a plurality of intermittency notches and/or continuity notches formed on a fiber prepreg material along at least one direction to make the fiber prepreg material soft and suitable for molding.

2. The semi-continuity fiber prepreg material of claim 1, wherein the fiber prepreg material is a fiber prepreg fabric material which is formed by impregnating a fiber fabric into a resin and baking the impregnated fiber fabric into a semi-solid state.

3. The semi-continuity fiber prepreg material of claim 1, wherein the plurality of intermittency notches are formed in a region of the fiber prepreg material, the region is a rectangle or a square.

4. The semi-continuity fiber prepreg material of claim 1, wherein the at least one direction comprises a first direction and a second direction, the first direction and the second direction each is a transverse chopping or a vertical chopping respectively.

5. A method of manufacturing a semi-continuity fiber prepreg material, comprising the step of:
generating a plurality of notches on a fiber prepreg material along at least one direction, wherein the plurality of notches are intermittency notches or continuity notches, so that the fiber prepreg material forms the semi-continuity fiber prepreg material which is soft and suitable for molding.

6. The method of claim 5, wherein the fiber prepreg material is a fabric prepreg material which is formed by immersing a fiber fabric into a resin and baking the immersed fiber fabric into a semi-solid state.

7. The method of claim 5, wherein the at least one direction comprises a first direction and a second direction, the first direction and the second direction is each a transverse chopping or a vertical chopping respectively.

8. A composite material manufacturing method using semi-continuity fiber prepreg material, comprising the steps of:
(a) rolling a semi-continuity fiber prepreg material to be a tube billet or a cylinder billet;
(b) putting the tube billet or the cylinder billet into a forming mold; and
(c) providing an axial pressure via a hot pressing machine and the forming temperature to make the tube billet or the cylinder billet become a composite material.

9. The method of claim 8, wherein the fiber prepreg material is a fabric prepreg material which is formed by impregnating a fiber fabric into a resin and baking the impregnated fiber fabric into a semi-solid state.

10. The method of claim 8, wherein the semi-continuity fiber prepreg material is made through the steps of:
generating a plurality of notches on a fiber prepreg material along at least one direction, wherein the plurality of notches are intermittency notches or continuity notches, so that the fiber prepreg material forms the semi-continuity fiber prepreg material which is soft and suitable for molding.

11. The method of claim 10, wherein the at least one direction comprises a first direction and a second direction, the first direction and the second direction can each be a transverse chopping or a vertical chopping respectively.
